(19) United States
(12) Patent Application Publication
(10) Pub. No.: US 2003/0103426 A1
(43) Pub. Date: Jun. 5, 2003

(54) Optical disc playback apparatus

(75) Inventor: Yoshihisa Fujimori, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/199,121

(22) Filed: Jul. 22, 2002

(30) Foreign Application Priority Data
Dec. 5, 2001 (JP) 2001-370949

(51) Int. Cl. G11B 7/095

(52) U.S. Cl. 369/44.36; 369/47.28

(57) ABSTRACT

In an event of deviation of focusing or tracking from an optimum point, a PLL gain control circuit outputs control signals to decrease the open loop gain of a PLL circuit. In response to the control signals, the PLL circuit decreases the frequency of comparison by a phase detector, decreases the current amount from the constant current circuit, decreases the combined resistance value of a filter circuit, and increases the divisor used by a frequency divider. By these operations, the open loop gain of the PLL circuit decreases from the level adopted during normal operation, and thus the property of the PLL circuit of following the disc playback signal is degraded. This enables generation of an extraction clock kept stable irrespective of a low-reliable disc playback signal. As a result, occurrence of disc read errors is reduced.

### BACKGROUND OF THE INVENTION

The present invention relates to optical disc playback apparatuses such as CD players, CD-ROM drives, DVD players, DVD-ROM drives and MD players.

An optical disc playback apparatus is provided with a PLL circuit for generating an extraction clock synchronized with a playback signal from an optical disc. The extraction clock generated by the PLL circuit is used for signal processing such as decoding and correction of the playback signal. To precisely trace information recorded on an optical disc, it is necessary both to focus a laser beam on the recording face of the optical disc (focusing) and move a pickup along spirally-recorded information on the optical disc (tracking). The optical disc playback apparatus is therefore provided with an optical servo system for realizing the focusing and tracking servos.

The PLL circuit for generating an extraction clock operates irrespective of the optical servo system. Therefore, when focusing and tracking deviate from an optimum point and an abnormal playback signal is generated, the PLL circuit will continue generation of an extraction clock with the same open loop gain as that adopted during normal operation. This increases jitter in the extraction clock, and results in frequent occurrence of read errors.

### SUMMARY OF THE INVENTION

An object of the present invention is providing an optical disc playback apparatus capable of reducing occurrence of read errors.

According to one aspect of the invention, the optical disc playback apparatus includes a PLL circuit, a tracking error detection circuit and a gain control circuit. The PLL circuit generates an extraction clock synchronized with a disc playback signal. The tracking error detection circuit detects a tracking error amount at a disc playback position. The gain control circuit generates a control signal corresponding to the tracking error amount detected by the tracking error detection circuit. The PLL circuit generates the extraction clock with a loop gain corresponding to the control signal from the gain control circuit.

According to another aspect of the invention, the optical disc playback apparatus includes a PLL circuit, a focusing error detection circuit and a gain control circuit. The PLL circuit generates an extraction clock synchronized with a disc playback signal. The focusing error detection circuit detects a focusing error amount at a disc playback position. The gain control circuit generates a control signal corresponding to the focusing error amount detected by the focusing error detection circuit. The PLL circuit generates the extraction clock with a loop gain corresponding to the control signal from the gain control circuit.

According to yet another aspect of the invention, the optical disc playback apparatus includes a PLL circuit, a tracking error detection circuit, a focusing error detection circuit and a gain control circuit. The PLL circuit generates an extraction clock synchronized with a disc playback signal. The tracking error detection circuit detects a tracking error amount at a disc playback position. The focusing error detection circuit detects a focusing error amount at the disc playback position. The gain control circuit generates a control signal corresponding to the tracking error amount detected by the tracking error detection circuit and the focusing error amount detected by the focusing error detection circuit. The PLL circuit generates the extraction clock with a loop gain corresponding to the control signal from the gain control circuit.

In the optical disc playback apparatus described above, in an event of increase of the tracking error amount detected by the tracking error detection circuit and/or the focusing error amount detected by the focusing error detection circuit, the gain control circuit sends a control signal instructing to decrease the loop gain to the PLL circuit. In response to the control signal, the PLL circuit decreases the loop gain. For example, the gain control circuit outputs a first control signal when the tracking error amount detected by the tracking error detection circuit and/or the focusing error amount detected by the focusing error detection circuit exceed respective predetermined values. In response to the first control signal from the gain control circuit, the PLL circuit decreases the loop gain from the level adopted during normal operation. With further increase of the tracking error amount and/or the focusing error amount, the gain control circuit outputs a second control signal. In response to the second control signal from the gain control circuit, the PLL circuit further decreases the loop gain. In this way, the PLL circuit decreases the loop gain with increase of the tracking error amount detected by the tracking error detection circuit and/or the focusing error amount detected by the focusing error detection circuit. This degrades the property of the PLL circuit of following the disc playback signal, and thus enables generation of an extraction clock kept stable irrespective of a low-reliable disc playback signal. As a result, occurrence of disc read errors is reduced.

Preferably, the PLL circuit includes a phase detector, a constant current circuit, a filter circuit and a voltage-controlled oscillator. The phase detector compares the phase of the disc playback signal with the phase of the extraction clock and outputs a signal corresponding to the resultant phase difference. The constant current circuit outputs a current corresponding to the signal from the phase detector. The filter circuit converts the current output from the constant current circuit to a voltage and outputs the voltage. The voltage-controlled oscillator generates a clock having a frequency corresponding to the level of the voltage output from the filter circuit.

Preferably, the constant current circuit outputs a current of an amount corresponding to the control signal from the gain control circuit.

In the optical disc playback apparatus described above, in an event of increase of the tracking error amount detected by the tracking error detection circuit and/or the focusing error amount detected by the focusing error detection circuit, the gain control circuit sends a control signal instructing to decrease the loop gain to the PLL circuit. In response to the control signal, the constant current circuit decreases the amount of the output current. For example, the gain control circuit outputs a first control signal when the tracking error amount detected by the tracking error detection circuit and/or the focusing error amount detected by the focusing error detection circuit exceed respective predetermined values. In response to the first control signal from the gain control circuit, the constant current circuit decreases the amount of the output current from the level adopted during normal operation. With further increase of the tracking error amount and/or the focusing error amount, the gain control circuit outputs a second control signal. In response to the second control signal from the gain control circuit, the constant current circuit further decreases the amount of the output current. In this way, the constant current circuit decreases the amount of the output current with increase of the tracking error amount detected by the tracking error detection circuit and/or the focusing error amount detected by the focusing error detection circuit. With the decrease of the amount of the output current from the constant current circuit, the loop gain of the PLL circuit decreases.

Preferably, the filter circuit includes a resistance and a capacitor, which are connected between an output node of the constant current circuit and a node for receiving a predetermined fixed voltage. The resistance value of the resistance is varied with the control signal from the gain control circuit.

In the optical disc playback apparatus described above, in an event of increase of the tracking error amount detected by the tracking error detection circuit and/or the focusing error amount detected by the focusing error detection circuit, the gain control circuit sends a control signal instructing to decrease the loop gain to the PLL circuit. In response to the control signal, the filter circuit decreases the resistance value of the resistance. For example, the gain control circuit outputs a first control signal when the tracking error amount detected by the tracking error detection circuit and/or the focusing error amount detected by the focusing error detection circuit exceed respective predetermined values. In response to the first control signal from the gain control circuit, the filter circuit decreases the resistance value of the resistance from that adopted during normal operation. With further increase of the tracking error amount and/or the focusing error amount, the gain control circuit outputs a second control signal. In response to the second control signal from the gain control circuit, the filter circuit further decreases the resistance value of the resistance. In this way, the filter circuit decreases the resistance value of the resistance with increase of the tracking error amount detected by the tracking error detection circuit and/or the focusing error amount detected by the focusing error detection circuit. With the decrease of the resistance value of the resistance, the loop gain of the PLL circuit decreases.

Preferably, the PLL circuit further includes a frequency divider. The frequency divider divides the frequency of the clock from the voltage-controlled oscillator and outputs the result as the extraction clock. The frequency divider divides the frequency of the clock from the voltage-controlled oscillator by a divisor corresponding to the control signal from the gain control circuit.

In the optical disc playback apparatus described above, in an event of increase of the tracking error amount detected by the tracking error detection circuit and/or the focusing error amount detected by the focusing error detection circuit, the gain control circuit sends a control signal instructing to decrease the loop gain to the PLL circuit. In response to the control signal, the frequency divider increases the divisor. For example, the gain control circuit outputs a first control signal when the tracking error amount detected by the tracking error detection circuit and/or the focusing error amount detected by the focusing error detection circuit exceed respective predetermined values. In response to the first control signal from the gain control circuit, the frequency divider increases the divisor from the level adopted during normal operation. With further increase of the tracking error amount and/or the focusing error amount, the gain control circuit outputs a second control signal. In response to the second control signal from the gain control circuit, the frequency divider further increases the divisor. In this way, the frequency divider increases the divisor with increase of the tracking error amount detected by the tracking error detection circuit and/or the focusing error amount detected by the focusing error detection circuit. With the increase of the divisor of frequency division, the loop gain of the PLL circuit decreases.

Preferably, the phase detector compares the phase of the disc playback signal with the phase of the extraction clock at a frequency corresponding to the control signal from the gain control circuit.

In the optical disc playback apparatus described above, in an event of increase of the tracking error amount detected by the tracking error detection circuit and/or the focusing error amount detected by the focusing error detection circuit increase, the gain control circuit sends a control signal instructing to decrease the loop gain to the PLL circuit. In response to the control signal, the phase detector decreases the frequency of comparison. For example, the gain control circuit outputs a first control signal when the tracking error amount detected by the tracking error detection circuit and/or the focusing error amount detected by the focusing error detection circuit exceed respective predetermined values. In response to the first control signal from the gain control circuit, the phase detector decreases the frequency of comparison from the level adopted during normal operation. With further increase of the tracking error amount and/or the focusing error amount, the gain control circuit outputs a second control signal. In response to the second control signal from the gain control circuit, the phase detector further decreases the frequency of comparison. In this way, the phase detector decreases the frequency of comparison with increase of the tracking error amount detected by the tracking error detection circuit and/or the focusing error amount detected by the focusing error detection circuit. With the decrease of the frequency of comparison by the phase detector, the loop gain of the PLL circuit decreases.

### BRIEF DESCRIPTION OF THE DRAWINGS

FIG. 1 is a block diagram of an optical disc playback apparatus of an embodiment of the present invention.

FIG. 2 is a block diagram of a PLL gain control circuit shown in FIG. 1.

FIG. 3 shows an example of the relationship between the error amount input into a gain arithmetic circuit shown in FIG. 2 and the PLL gain coefficient output from the gain arithmetic circuit.

FIG. 4 shows an example of the details of gain control signals output from a control signal generation circuit shown in FIG. 2.

FIG. 5 is a block diagram of a PLL circuit shown in FIG. 1.

FIG. 6 is a timing chart for illustration of the frequency of comparison by a phase detector shown in FIG. 5.

FIG. 7 is another timing chart for illustration of the frequency of comparison by the phase detector shown in FIG. 5.

FIG. 8 is yet another timing chart for illustration of the frequency of comparison by the phase detector shown in FIG. 5.

FIG. 9 shows the states of a RF signal and a focusing error amount during focusing deviation.

FIG. 10 shows the open loop gain property of the PLL circuit shown in FIG. 1.

FIG. 11 shows the states of a RF signal and a tracking error amount during tracking deviation.

FIG. 12 shows another example of the relationship between the error amount input into the gain arithmetic circuit shown in FIG. 2 and the PLL gain coefficient output from the gain arithmetic circuit.

FIG. 13 shows another example of the details of gain control signals output from the control signal generation circuit shown in FIG. 2.

FIG. 14 is a block diagram of a digital PLL circuit.

### DESCRIPTION OF THE PREFERRED EMBODIMENTS

Hereinafter, a preferred embodiment of the present invention will be described in detail with reference to the accompanying drawings.

<Configuration of Optical Disc Playback Apparatus>

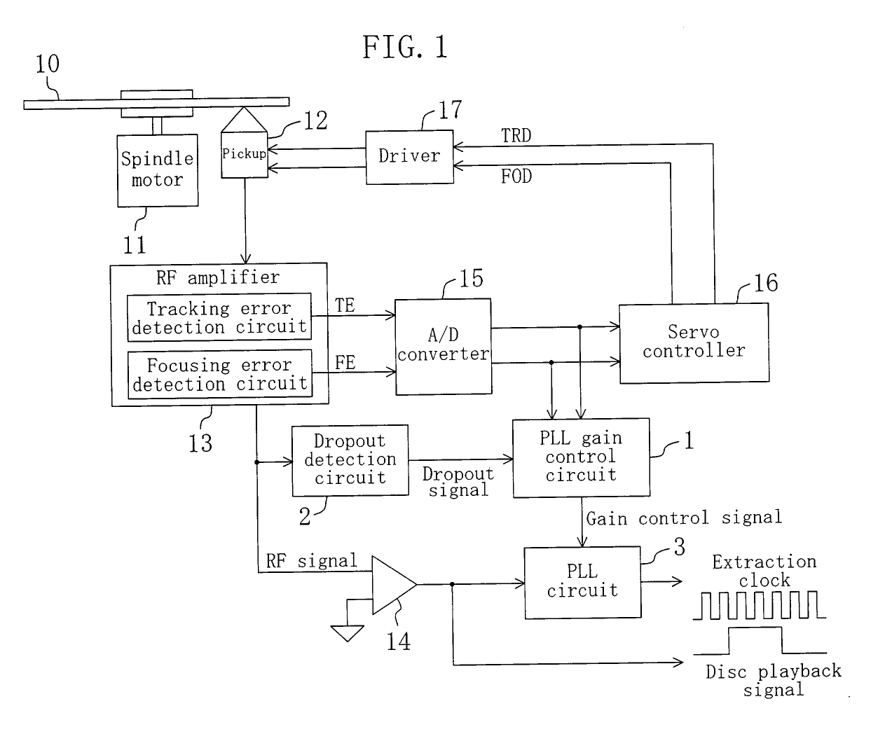

FIG. 1 illustrates the entire configuration of an optical disc playback apparatus of an embodiment of the present invention. The optical disc playback apparatus shown in FIG. 1 includes a PLL gain control circuit 1, a dropout detection circuit 2, a PLL circuit 3, a spindle motor 11, a pickup 12, a RF amplifier 13, a data slicer 14, an A/D converter 15, a servo controller 16 and a driver 17.

An optical disc 10 such as a CD and a DVD is rotated with the spindle motor 11. The pickup 12 illuminates the optical disc 10 with laser light, detects return light from the optical disc 10, converts the return light to a voltage value, and outputs the voltage value. The output from the pickup 12 is amplified by the RF amplifier 13 and then digitized by the data slicer 14. In this way, information recorded on the optical disc 10 is recovered as a disc playback signal. The disc playback signal is then subjected to processing such as decoding and correction in a playback signal processing section (not shown) at a later stage. For the processing in the later-stage playback signal processing section, an extraction clock synchronized with the disc playback signal is necessary. The PLL circuit 3 generates this extraction clock.

To precisely trace information recorded on the optical disc 10, it is necessary both to focus a laser beam on the recording face of the optical disc 10 (focusing) and move the pickup 12 along the information recorded spirally on the optical disc 10 (tracking). For this purpose, optical servo control is performed in the following manner, separately from the playback signal processing. A tracking error detection circuit and a focusing error detection circuit in the RF amplifier 13 generate a tracking error amount TE and a focusing error amount FE, respectively, based on the output from the pickup 12. The tracking error amount TE indicates an amount of deviation from a tracking optimum point, and the focusing error amount FE indicates an amount of deviation from a focusing optimum point. The tracking error amount TE and the focusing error amount FE are converted to digital values by the A/D converter 15. Based on the digitally converted tracking and focusing error amounts TE and FE, the servo controller 16 generates a tracking drive signal TRD and a focusing drive signal FOD set to cancel the tracking error amount TE and the focusing error amount FE, and outputs the signals to the driver 17. In response to the tracking drive signal TRD and the focusing drive signal FOD, the driver 17 operates a drive mechanism (not shown) of the pickup 12 to adjust the position of the pickup 12. By this optical servo control, precise tracing of information on the optical disc 10 is possible.

The dropout detection circuit 2 outputs a dropout signal to the PLL gain control circuit 1 when it detects a dropout of the RF signal from the RF amplifier 13.

The PLL gain control circuit 1 generates gain control signals based on the tracking error amount TE and the focusing error amount FE from the A/D converter 15 and the dropout signal from the dropout detection circuit 2, and outputs the gain control signals to the PLL circuit 3. The PLL circuit 3 changes the open loop gain according to the gain control signals from the PLL gain control circuit 1.

<Internal Configuration of Gain Control Circuit>

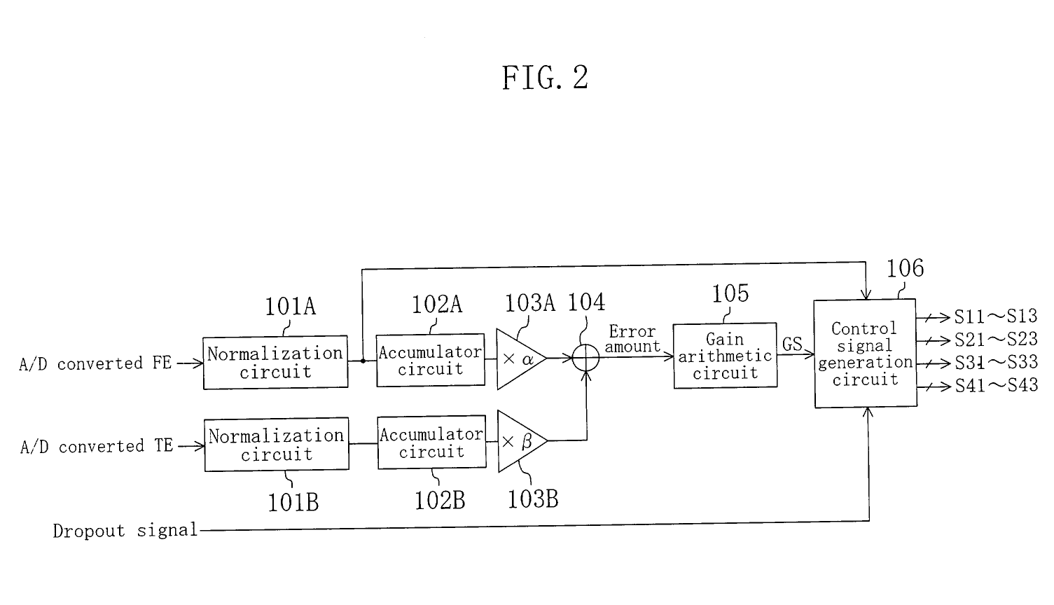

As shown in FIG. 2, the PLL gain control circuit 1 includes normalization circuits 101A and 101B, accumulator circuits 102A and 102B, multipliers 103A and 103B, an adder 104, a gain arithmetic circuit 105 and a control signal generation circuit 106. The PLL gain control circuit 1 having this configuration operates in the following manner.

The focusing error amount FE and the tracking error amount TE digitized by the A/D converter 15 shown in FIG. 1 are input into the normalization circuits 101A and 101B, respectively. The normalization circuits 101A and 101B store the maximums of the focusing error amount FE and the tracking error amount TE observed during optical servo adjustment at the disc startup, and hold respective coefficients by which the maximums are kept at predetermined values. The normalization circuits 101A and 101B multiply the input focusing error amount FE and tracking error amount TE by the respective coefficients and output the results. By this processing, variations in focusing error amount FE and tracking error amount TE due to variations in the properties of the pickup 12 and the RF amplifier 13 are corrected (normalized).

The focusing error amount FE and tracking error amount TE normalized by the normalization circuits 101A and 101B are input into the accumulator circuits 102A and 102B, respectively, for accumulation for a predetermined time period. By setting the accumulation period short, the accumulator circuits 102A and 102B output values immediately responding to changes in focusing error amount FE and tracking error amount TE. By setting the accumulation period long, the accumulator circuits 102A and 102B output roughly the averages of the amounts during the period. The setting of the accumulation period is determined depending on the properties of the optical disc playback apparatus. The output value is greater as the accumulation period is longer. Herein, therefore, the accumulator circuits 102A and 102B are configured to divide the accumulated values by a value corresponding to the accumulation period and output the resultant values.

The outputs of the accumulator circuits 102A and 102B are weighted by being multiplied by coefficients α and β by the multipliers 103A and 103B, respectively, and then added together by the adder 104. In general, focusing deviation affects the change of the RF signal more greatly. Therefore, the coefficients α and β are set so that α>β is satisfied. The addition result from the adder 104 is input into the gain arithmetic circuit 105 as the final error amount.

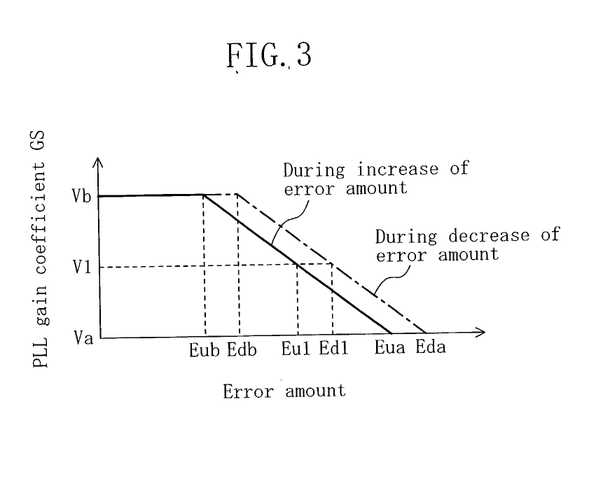

The gain arithmetic circuit 105 calculates a PLL gain coefficient GS according to the input error amount, and outputs the result to the control signal generation circuit 106. The gain arithmetic circuit 105 calculates the PLL gain coefficient GS in different ways of correspondence with the error amount between during increase of the error amount and during decrease thereof. Hereinafter, the operation during increase of the error amount and that during decrease of the error amount will be described separately with reference to FIG. 3.

(1) During Increase of Error Amount

Vb is output as the PLL gain coefficient GS until the error amount reaches Eub. As the error amount increases from Eub to Eu1, the PLL gain coefficient GS is gradually decreased from Vb. When the error amount reaches Eu1, V1 is output as the PLL gain coefficient GS. The PLL gain coefficient GS is again gradually decreased from V1 as the error amount increases from Eu1 to Eua. Once the error amount reaches Eua, Va is output as the PLL gain coefficient GS.

(2) During Decrease of Error Amount

Va is output as the PLL gain coefficient GS until the error amount reaches Eda (Eua<Eda). As the error amount decreases from Eda to Ed1, the PLL gain coefficient GS is gradually increased from Va. When the error amount reaches Ed1 (Eu1<Ed1), V1 is output as the PLL gain coefficient GS. The PLL gain coefficient GS is again gradually increased from V1 as the error amount decreases from Ed1 to Edb (Eub<Edb). Once the error amount reaches Edb, Vb is output as the PLL gain coefficient GS.

As is understood from the above description, the gain arithmetic circuit 105 starts the decrease of the PLL gain coefficient GS earlier during increase of the error amount, and starts the increase thereof earlier during decrease of the error amount. By this operation, it is possible both to decrease the open loop gain of the PLL circuit 3 early during occurrence of deviation of focusing and tracking and resume the open loop gain of the PLL circuit 3 early during correction of deviated focusing and tracking.

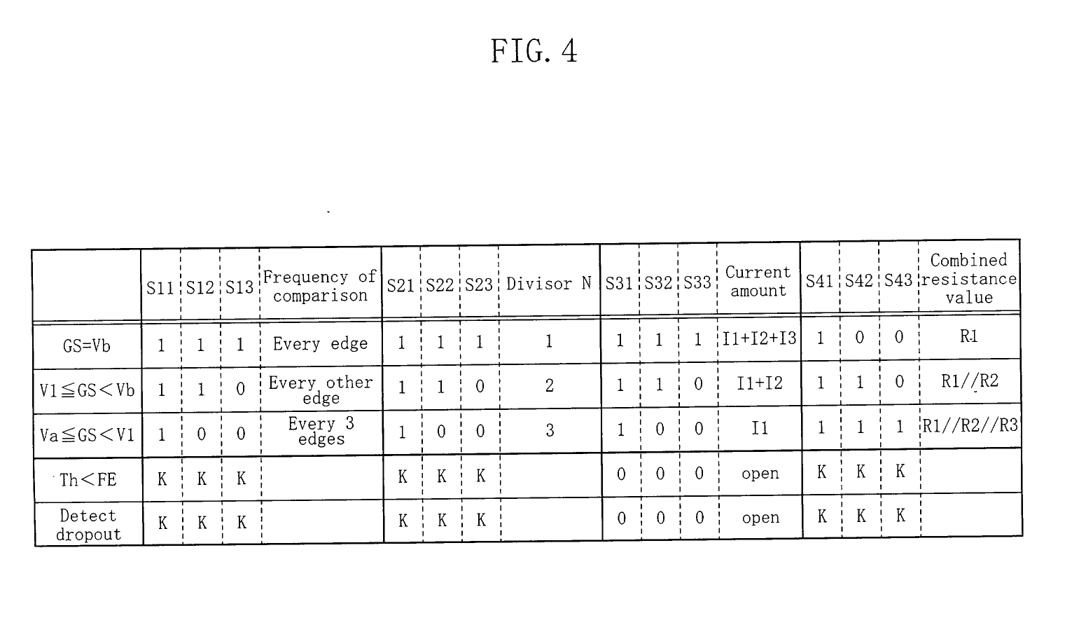

The control signal generation circuit 106 outputs gain control signals S11 to S13, S21 to S23, S31 to S33 and S41 to S43 determined according to the PLL gain coefficient GS from the gain arithmetic circuit 105. More specifically, as shown in FIG. 4, when the PLL gain coefficient GS is equal to Vb (GS=Vb), the control signal generation circuit 106 outputs the gain control signals (S11=1, S12=1, S13=1, S21=1, S22=1, S23=1, S31=1, S32=1, S33=1, S41=1, S42=0 and S43=0). When the PLL gain coefficient GS is smaller than Vb and equal to or greater than V1 (V1≦GS<Vb), the control signal generation circuit 106 outputs the gain control signals (S11=1, S12=1, S13=0, S21=1, S22=1, S23=0, S31=1, S32=1, S33=0, S41=1, S42=1 and S43=0). When the PLL gain coefficient GS is smaller than V1 and equal to or greater than Va (Va≦GS<V1), the control signal generation circuit 106 outputs the gain control signals (S11=1, S12=0, S13=0, S21=1, S22=0, S23=0, S31=1, S32=0, S33=0, S41=1, S42=1 and S43=1).

As an exception, when the focusing error amount FE normalized by the normalization circuit 101A exceeds a predetermined value Th (Th<FE) and/or when the dropout signal is output from the dropout detection circuit 2, the control signal generation circuit 106 changes the gain control signals S31 to S33 to (S31=0, S32=0 and S33=0) while remaining the other gain control signals S11 to S13, S21 to S23 and S41 to S43 unchanged. In FIG. 4, output of the previous value without change is represented by “k”.

<Internal Configuration of PLL Circuit>

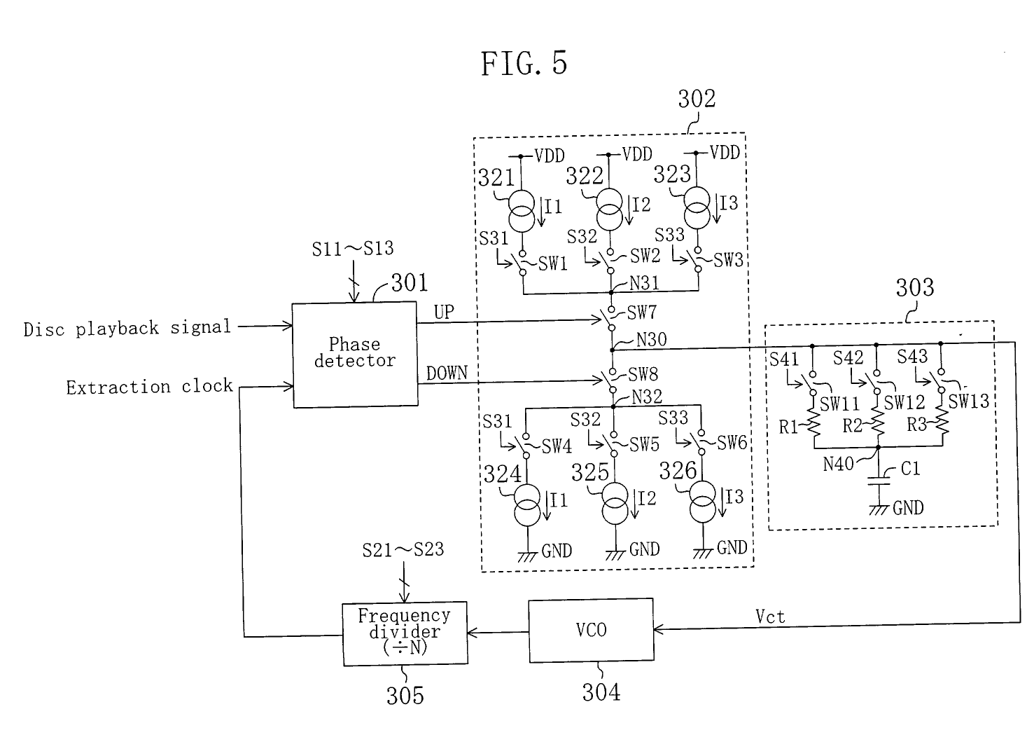

FIG. 5 illustrates an internal configuration of the PLL circuit 3 shown in FIG. 1. Referring to FIG. 5, the PLL circuit 3 includes a phase detector 301, a constant current circuit 302, a filter circuit 303, a voltage-controlled oscillator (VCO) 304 and a frequency divider 305.

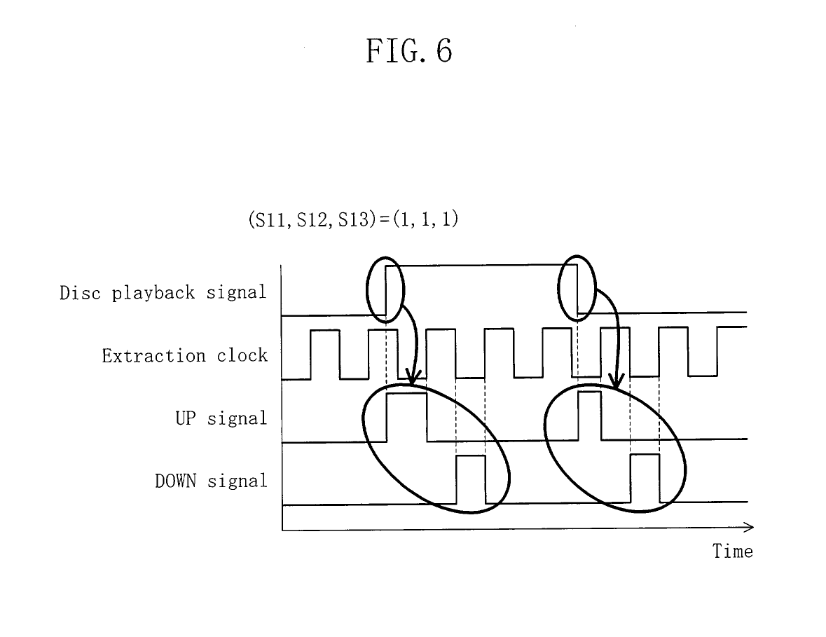

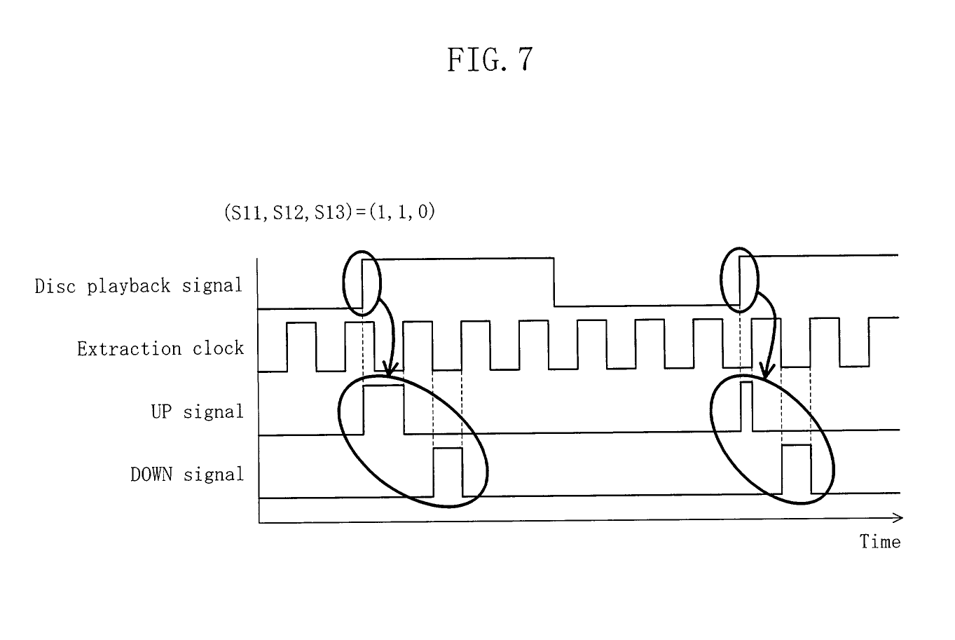

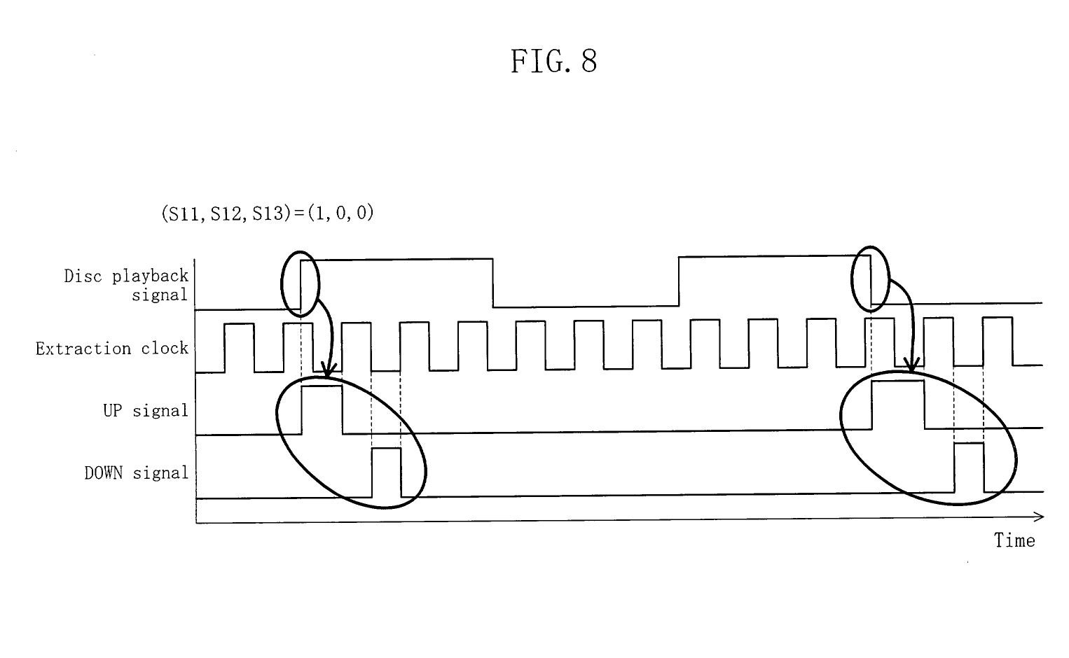

The phase detector 301 compares the phase of the disc playback signal from the data slicer 14 with the phase of the extraction clock from the frequency divider 305, and outputs UP and DOWN signals corresponding to the resultant phase difference. The UP signal is a signal activated during the time period from an edge of the disc playback signal until the first rise of the extraction clock after this edge of the disc playback signal. The DOWN signal is a signal activated during the time period corresponding to a half of one cycle of the extraction clock. The phase detector 301 compares the phase of the disc playback signal with the phase of the extraction clock at a frequency corresponding to the gain control signals S11 to S13. More specifically, when the gain control signals S11 to S13 are (S11, S12, S13)=(1, 1, 1), the phase detector 301 outputs the UP and DOWN signals activated for every edge of the disc playback signal as shown in FIG. 6. When the gain control signals S11 to S13 are (S11, S12, S13)=(1, 1, 0), the phase detector 301 outputs the UP and DOWN signals activated for every other edge (that is, every rising or falling edge) of the disc playback signal as shown in FIG. 7. In FIG. 7, the UP and DOWN signals are activated for every rising edge of the disc playback signal. When the gain control signals S11 to S13 are (S11, S12, S13)=(1, 0, 0), the phase detector 301 outputs the UP and DOWN signals activated for every three edges of the disc playback signal as shown in FIG. 8. In this way, the phase detector 3 compares the phase of the disc playback signal with the phase of the extraction clock at a frequency corresponding to the gain control signals S11 to S13, and outputs the UP and DOWN signals corresponding to the resultant phase difference.

The constant current circuit 302 includes current sources 321 to 326 and switches SW1 to SW8.

The current sources 321 to 323 are connected in parallel between the power supply node VDD receiving a supply voltage and a node N31, and feed currents I1 to I3 to the node N31. The switches SW1 to SW3 are placed between the output nodes of the current sources 321 to 323 and the node N31, and switch on/off the connection between the output nodes of the current sources 321 to 323 and the node N31 according to the gain control signals S31 to S33. Specifically, the switches SW1 to SW3 respectively connect the output nodes of the current sources 321 to 323 and the node N31 when the gain control signals S31 to S33 are “1”, and disconnect the output nodes of the current sources 321 to 323 from the node N31 when the gain control signals S31 to S33 are “0”.

The switch SW7 is placed between the node N31 and an output node N30, and switches on/off the connection between the node N31 and the output node N30 in response to the UP signal from the phase detector 301. Specifically, the switch SW7 connects the node N31 and the output node N30 when the UP signal from the phase detector 301 is activated, and disconnects the node N31 from the output node N30 when the UP signal is inactivated. The switch SW8 is placed between the output node N30 and a node N32, and switches on/off the connection between the output node N30 and the node N32 in response to the DOWN signal from the phase detector 301. Specifically, the switch SW8 connects the output node N30 and the node N32 when the DOWN signal from the phase detector 301 is activated, and disconnects the output node N30 from the node N32 when the DOWN signal is inactivated.

The current sources 324 to 326 are connected in parallel between the node N32 and the ground node GND receiving a ground voltage, and draw the currents I1 to I3 from the node N32. The switches SW4 to SW6 are placed between the node N32 and the input nodes of the current sources 324 to 326, and switch on/off the connection between the node N32 and the input nodes of the current sources 324 to 326 according to the gain control signals S31 to S33. Specifically, the switches SW4 to SW6 respectively connect the node N32 and the input nodes of the current sources 324 to 326 when the gain control signals S31 to S33 are “1”, and disconnect the node N32 from the input nodes of the current sources 324 to 326 when the gain control signals S31 to S33 are “0”.

In the constant current circuit 302 having the configuration described above, a current is fed to the output node N30 in response to activation of the UP signal and is drawn from the output node N30 in response to activation of the DOWN signal. This results in that a current corresponding to the difference between the width of the activated UP signal and the width of the activated DOWN signal, that is, the phase difference between the disc playback signal and the extraction clock, is output from or drawn to the output node N30. In addition, the constant current circuit 302 feeds or draws a current of an amount corresponding to the gain control signals S31 to S33. When the gain control signals S31 to S33 are (S31, S32, S33)=(1, 1, 1), the constant current circuit 302 feeds or draws a current of the amount (I1+I2+I3) to or from the output node N30. When the gain control signals S31 to S33 are (S31, S32, S33)=(1, 1, 0), the constant current circuit 302 feeds or draws a current of the amount (I1+I2) to or from the output node N30. When the gain control signals S31 to S33 are (S31, S32, S33)=(1, 0, 0), the constant current circuit 302 feeds or draws a current of the amount I1 to or from the output node N30. Note that when the gain control signals S31 to S33 are (S31, S32, S33)=(0, 0, 0), the constant current circuit 302 puts the output node N30 in the open state.

The filter circuit 303 includes switches SW11 to SW13, resistances R1 to R3 and a capacitor C1. The resistances R1 to R3 are connected in parallel between the output node N30 of the constant current circuit 302 and a node N40. The switches SW11 to SW13 are placed between the output node N30 of the constant current circuit 302 and the resistances R1 to R3, respectively, and switch on/off the connection between the output node N30 of the constant current circuit 302 and the resistances R1 to R3 according to the gain control signals S41 to S43. Specifically, the switches SW11 to SW13 respectively connect the output node N30 and the resistances R1 to R3 when the gain control signals S41 to S43 are “1”, and disconnect the output node N30 from the resistances R1 to R3 when the gain control signals S41 to S43 are “0”. The capacitor C1 is connected between the node N40 and the ground node GND.

In the filter circuit 303 having the configuration described above, the capacitor C1 is charged with the current fed to the output node N30 of the constant current circuit 302 and discharged with the current drawn from the output node N30. As a result, a current corresponding to the difference between the width of the activated UP signal and the width of the activated DOWN signal, that is, the phase difference between the disc playback signal and the extraction clock, is charged into or discharged from the capacitor C1. The filter circuit 303 feeds a control voltage Vct of a level corresponding to the charge amount accumulated in the capacitor C1 to the voltage-controlled oscillator 304. More specifically, the filter circuit 303 smoothes the current from the constant current circuit 302, converts the smoothed current to the control voltage Vct, and feeds the control voltage Vct to the voltage-controlled oscillator 304. In addition, the filter circuit 303 changes the combined resistance value existing between the output node N30 of the constant current circuit 302 and the node N40 according to the gain control signals S41 to S43. That is, the filter circuit 303 converts the current from the constant current circuit 302 to the control voltage Vct with a transfer function determined based on the combined resistance value between the output node N30 of the constant current circuit 302 and the node N40 and the capacitance value of the capacitor C1. When the gain control signals S41 to S43 are (S41, S42, S43)=(1, 0, 0), the combined resistance value between the output node N30 and the node N40 is equal to the resistance value of the resistance R1. When the gain control signals S41 to S43 are (S41, S42, S43)=(1, 1, 0), the combined resistance value between the output node N30 and the node N40 is equal to the combined resistance value obtained when the resistances R1 and R2 are connected in parallel. When the gain control signals S41 to S43 are (S41, S42, S43)=(1, 1, 1), the combined resistance value between the output node N30 and the node N40 is equal to the combined resistance value obtained when the resistances R1 to R3 are connected in parallel.

The voltage-controlled oscillator 304 generates a clock having a frequency corresponding to the level of the control voltage Vct from the filter circuit 303.

The frequency divider 305 divides the frequency of the clock from the voltage-controlled oscillator 304 by a divisor N corresponding to the gain control signals S21 to S23, and outputs the result as the extraction clock. More specifically, when the gain control signals S21 to S23 are (S21, S22, S23)=(1, 1, 1), the frequency divider 305 does not divide (divides by 1) the frequency of the clock from the voltage-controlled oscillator 304 and outputs the result as the extraction clock. When the gain control signals S21 to S23 are (S21, S22, S23)=(1, 1, 0), the frequency divider 305 divides the frequency of the clock from the voltage-controlled oscillator 304 by 2 (N=2) and outputs the result as the extraction clock. When the gain control signals S21 to S23 are (S21, S22, S23)=(1, 0, 0), the frequency divider 305 divides the frequency of the clock from the voltage-controlled oscillator 304 by 3 (N=3) and outputs the result as the extraction clock.

<Adjustment of Open Loop Gain of PLL Circuit>

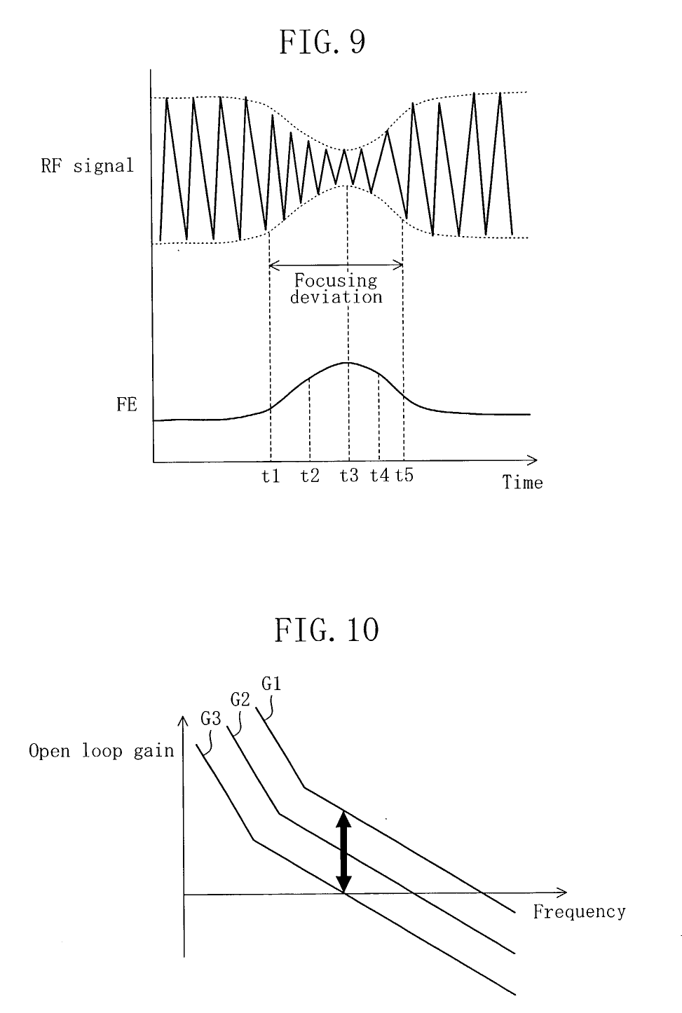

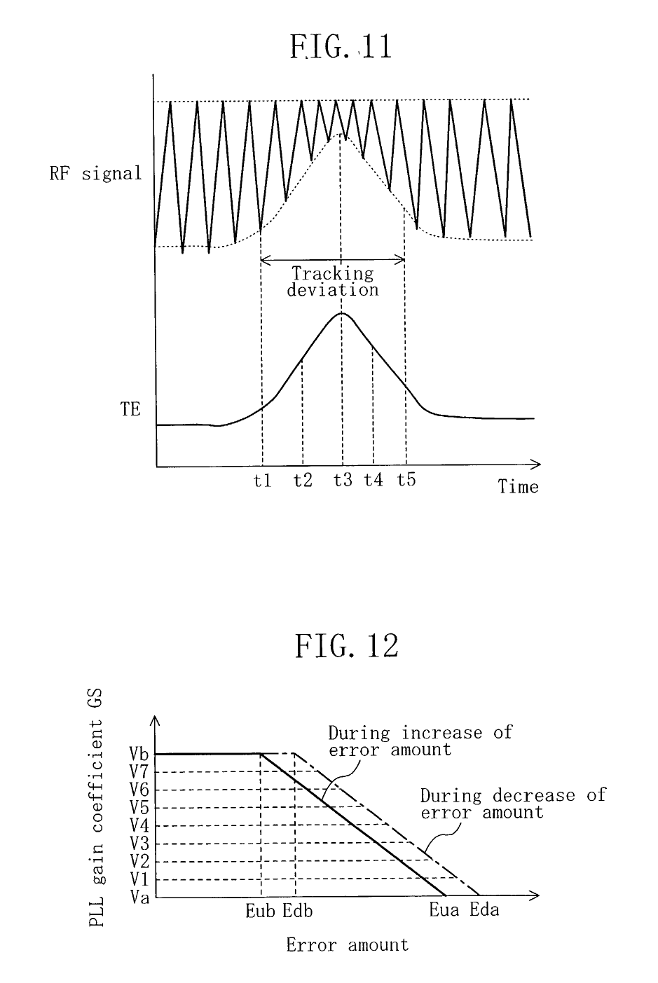

The optical disc playback apparatus shown in FIG. 1 adjusts the open loop gain of the PLL circuit 3 according to the focusing error amount FE and the tracking error amount TE. Hereinafter, adjustment of the open loop gain of the PLL circuit 3 according to the focusing error amount FE will be described with reference to FIG. 9.

Before time t1, focusing is under control following roughly an optimum point. In this state, the error amount output from the adder 104 of the PLL gain control circuit 1 is Eub or less. With the error amount Eub or less, the PLL gain coefficient GS output from the gain arithmetic circuit 105 is Vb as shown in FIG. 3. With GS=Vb, the gain control signals output from the control signal generation circuit 106 are (S11, S12, S13)=(1, 1, 1), (S21, S22, S23)=(1, 1, 1), (S31, S32, S33)=(1, 1, 1) and (S41, S42, S43)=(1, 0, 0) as shown in FIG. 4.

In response to the gain control signals described above, the phase detector 301 outputs the UP and DOWN signals activated for every edge of the disc playback signal as shown in FIG. 6.

Also, the switches SW1 to SW6 shown in FIG. 5 are turned on, to enable the constant current circuit 302 to feed or draw a current of the current amount (I1+I2+I3) to or from the output node N30 in response to activation of the UP signal or DOWN signal.

The switch SW11 shown in FIG. 5 is turned on while the switches SW12 and SW13 are turned off, so that the combined resistance value between the output node N30 of the constant current circuit 302 and the node N40 is equal to the resistance value of the resistance R1.

The frequency divider 305 shown in FIG. 5 sets the divisor N at 1. That is, the frequency divider 305 divides the frequency of the clock from the voltage-controlled oscillator 304 by 1 (that is, does not divide the frequency) and outputs the result as the extraction clock.

With the above operations, the open loop gain of the PLL circuit 3 in the state before time t1, that is, in the normal state, is as represented by G1 in FIG. 10.

At and around time t1 in FIG. 9, focusing starts deviating from the optimum point, and thus the focusing error amount starts increasing. After time t1, the error amount output from the adder 104 of the PLL gain control circuit 1 shown in FIG. 2 exceeds Eub. With the error amount exceeding Eub, the PLL gain coefficient GS output from the gain arithmetic circuit 105 decreases from Vb as shown in FIG. 3. With GS satisfying V1≦GS<Vb, the gain control signals output from the control signal generation circuit 106 are (S11, S12, S13)=(1, 1, 0), (S21, S22, S23)=(1, 1, 0), (S31, S32, S33)=(1, 1, 0) and (S41, S42, S43)=(1, 1, 0) as shown in FIG. 4.

In response to the gain control signals described above, the phase detector 301 outputs the UP and DOWN signals activated for every other edge (that is, every rising or falling edge) of the disc playback signal as shown in FIG. 7. This means that the phase detector 301 decreases the frequency of comparison between the phase of the disc playback signal and the phase of the extraction clock.

Also, the switches SW1, SW2, SW4 and SW5 shown in FIG. 5 are turned on while the switches SW3 and SW6 are turned off, to enable the constant current circuit 302 to feed or draw a current of the current amount (I1+I2) to or from the output node N30 in response to activation of the UP signal or DOWN signal. This means that the constant current circuit 302 decreases the current amount fed to or drawn from the output node N30.

The switches SW11 and SW12 shown in FIG. 5 are turned on while the switch SW13 is turned off, so that the combined resistance value between the output node N30 of the constant current circuit 302 and the node N40 is equal to the combined resistance value obtained when the resistances R1 and R2 are connected in parallel. This means that the filter circuit 303 decreases the combined resistance value.

The frequency divider 305 shown in FIG. 5 sets the divisor N at 2. This means that the frequency divider 305 increases the divisor N. That is, the frequency divider 305 divides the frequency of the clock from the voltage-controlled oscillator 304 by 2 and outputs the result as the extraction clock.

The open loop gain of the PLL circuit 3 has the following relationship with the frequency of phase comparison by the phase detector 301, the amount of the current fed or drawn by the constant current circuit 302, the combined resistance value of the filter circuit 303 and the divisor N of frequency division by the frequency divider 305.

Open loop gain ∝ (frequency of phase comparison×current amount×combined resistance value)/divisor N

Accordingly, the open loop gain of the PLL circuit 3 during the period from time t1 to time t2 is as represented by G2 in FIG. 10, which is lower than the open loop gain G1 obtained before time t1.

After time t2 in FIG. 9, the error amount output from the adder 104 of the PLL gain control circuit 1 shown in FIG. 2 exceeds Eu1. With the error amount exceeding Eu1, the PLL gain coefficient GS output from the gain arithmetic circuit 105 decreases from V1 as shown in FIG. 3. Therefore, with GS satisfying Va≦GS<V1, the gain control signals output from the control signal generation circuit 106 are (S11, S12, S13)=(1, 0, 0), (S21, S22, S23)=(1, 0, 0), (S31, S32, S33)=(1, 0, 0) and (S41, S42, S43)=(1, 1, 1) as shown in FIG. 4.

In response to the gain control signals described above, the phase detector 301 outputs the UP and DOWN signals activated for every three edges of the disc playback signal as shown in FIG. 8. This means that the phase detector 301 further decreases the frequency of comparison between the phase of the disc playback signal and the phase of the extraction clock.

Also, the switches SW1 and SW4 shown in FIG. 5 are turned on while the switches SW2, SW3, SW5 and SW6 are turned off, to enable the constant current circuit 302 to feed or draw a current of the current amount I1 to or from the output node N30 in response to activation of the UP signal or DOWN signal. This means that the constant current circuit 302 further decreases the current amount fed to or drawn from the output node N30.

The switches SW11 to SW13 shown in FIG. 5 are turned on, so that the combined resistance value between the output node N30 of the constant current circuit 302 and the node N40 is equal to the combined resistance value obtained when the resistances R1 to R3 are connected in parallel. This means that the filter circuit 303 further decreases the combined resistance value.

The frequency divider 305 shown in FIG. 5 sets the divisor N at 3. This means that the frequency divider 305 further increases the divisor N. That is, the frequency divider 305 divides the frequency of the clock from the voltage-controlled oscillator 304 by 3 and outputs the result as the extraction clock.

Accordingly, the open loop gain of the PLL circuit 3 during the period from time t2 to time t3 is as represented by G3 in FIG. 10, which is lower than the open loop gain G2 obtained during the period from time t1 time t2.

After time t3 in FIG. 9, the focusing error amount FE starts decreasing, and thus the error amount output from the adder 104 of the PLL gain control circuit 1 shown in FIG. 2 starts decreasing. After time t4, the error amount output from the adder 104 decreases from Ed1. With the error amount smaller than Ed1, the PLL gain coefficient GS output from the gain arithmetic circuit 105 becomes greater than V1 as shown in FIG. 3. With GS satisfying V1≦GS<Vb, the gain control signals output from the control signal generation circuit 106 are (S1, S12, S13)=(1, 1, 0), (S21, S22, S23)=(1, 1, 0), (S31, S32, S33)=(1, 1, 0) and (S41, S42, S43)=(1, 1, 0) as shown in FIG. 4.

In response to the gain control signals described above, the phase detector 301 increases the frequency of comparison between the phase of the disc playback signal and the phase of the extraction clock. The constant current circuit 302 increases the amount of the current fed to or drawn from the output node N30. The filter circuit 303 increases the combined resistance value. The frequency divider 305 decreases the divisor N.

Accordingly, the open loop gain of the PLL circuit 3 during the period from time t4 to time t5 is as represented by G2 in FIG. 10, which is higher than the open loop gain G3 obtained until time t4.

After time t5 in FIG. 9, the error amount output from the adder 104 of the PLL gain control circuit 1 shown in FIG. 2 decreases from Edb. With the error amount smaller than Edb, the PLL gain coefficient GS output from the gain arithmetic circuit 105 becomes Vb as shown in FIG. 3. Therefore, with GS satisfying GS=Vb, the gain control signals output from the control signal generation circuit 106 are (S11, S12, S13)=(1, 1, 1), (S21, S22, S23)=(1, 1, 1), (S31, S32, S33)=(1, 1, 1) and (S41, S42, S43)=(1, 0, 0) as shown in FIG. 4.

In response to the gain control signals described above, the phase detector 301 further increases the frequency of comparison between the phase of the disc playback signal and the phase of the extraction clock. The constant current circuit 302 further increases the amount of the current fed to or drawn from the output node N30. The filter circuit 303 further increases the combined resistance value. The frequency divider 305 further decreases the divisor N.

Accordingly, the open loop gain of the PLL circuit 3 after time t5 is as represented by G1 in FIG. 10, which is higher than the open loop gain G2 obtained until time t5. That is, the open loop gain in the normal state is resumed. In this way, the open loop gain of the PLL circuit 3 is resumed early during correction of deviated focusing.

As an exception, when the focusing error amount FE normalized by the normalization circuit 101A shown in FIG. 2 exceeds a predetermined value Th (Th<FE) and/or when the dropout signal is output from the dropout detection circuit 2, the control signal generation circuit 106 changes the gain control signals S31 to S33 to (S31=0, S32=0 and S33=0) as shown in FIG. 4. In response to this signal change, the switches SW1 to SW6 of the constant current circuit 302 shown in FIG. 5 are turned off. This results in that the output of the filter circuit 303 is held and an extraction clock with a fixed oscillating frequency is output from the frequency divider 305. In this way, it is possible to prevent the extraction clock from being disturbed with a further unreliable random disc playback signal.

In the above description, the open loop gain of the PLL circuit 3 was adjusted according to the focusing error amount FE. Adjustment of the open loop gain of the PLL circuit 3 according to the tracking error amount TE is also possible in substantially the same manner as that described above.

<Effect>

When return light from the optical disc 10 decreases due to deviation of focusing and/or tracking from an optimum point, the amplitude of the RF signal decreases causing increase in jitter and the like. This degrades the reliability of the disc playback signal from the data slicer 14. If the PLL circuit generates an extraction clock with the same open loop gain as that adopted in the normal state for such a low-reliable disc playback signal, jitter increases in the extraction clock, and this results in frequent occurrence of read errors.

To overcome the above problem, in the optical disc playback apparatus of the embodiment of the present invention, the PLL gain control circuit 1 outputs the control signals S11 to S13, S21 to S23, S31 to S33 and S41 to S43 to the PLL circuit 3 to decrease the open loop gain when the focusing error amount FE and/or the tracking error amount TE exceed respective predetermined values. In response to these control signals, the PLL circuit 3 decreases the frequency of comparison by the phase detector 301, decreases the amount of the current from the constant current circuit 302, decreases the combined resistance value of the filter circuit 303, and increases the divisor N by the frequency divider 305. By these operations, the open loop gain of the PLL circuit 3 decreases from the level adopted during normal operation, and thus, the property of the PLL circuit 3 of following the disc playback signal is degraded. This enables generation of an extraction clock kept stable irrespective of a low-reliable disc playback signal output from the data slicer 14, and as a result, occurrence of disc read errors is reduced.

<Alterations>

In the embodiment described above, all of the factors, that is, the frequency of phase comparison by the phase detector 301, the current amount from the constant current circuit 302, the combined resistance value of the filter circuit 303 and the divisor N of frequency division by the frequency divider 305, were changed according to the focusing error amount FE and/or the tracking error amount TE. Alternatively, part of these factors may be changed to adjust the open loop gain of the PLL circuit 3.

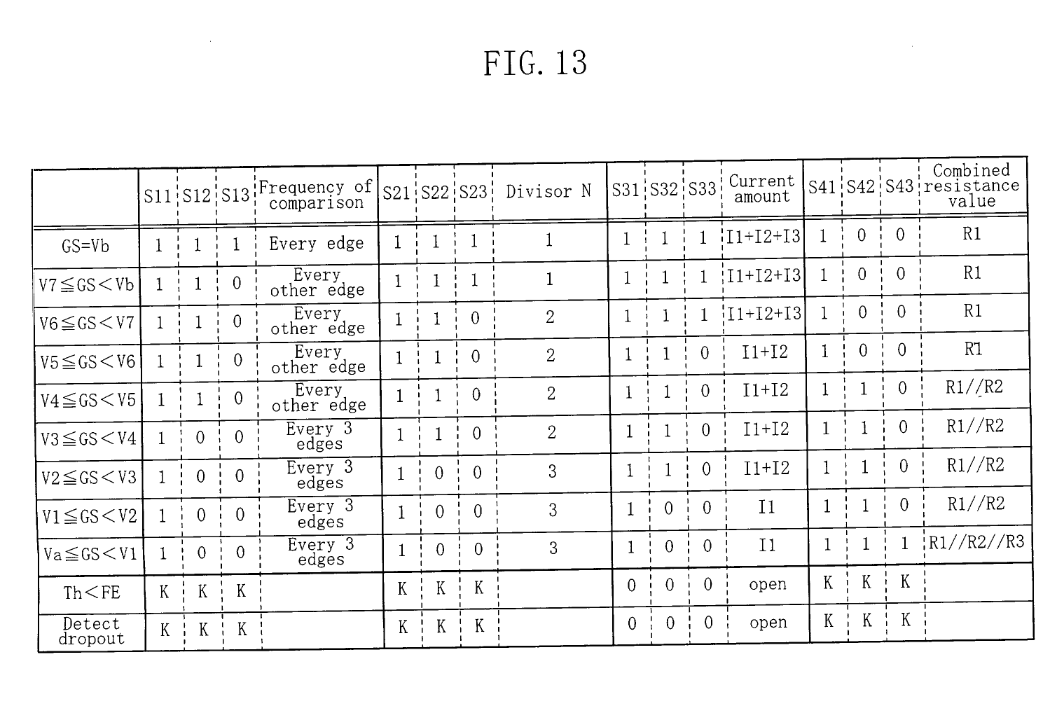

Further detailed adjustment of the open loop gain of the PLL circuit 3 is possible by combining the frequency of phase comparison by the phase detector 301, the current amount from the constant current circuit 302, the combined resistance value of the filter circuit 303 and the divisor N of frequency division by the frequency divider 305 according to the focusing error amount FE and/or the tracking error amount TE. For example, as shown in FIG. 12, the PLL gain coefficient GS (Vb, V7 to V1, Va) according to the input error amount is generated by the gain arithmetic circuit 105. The control signal generation circuit 106 generates gain control signals S11 to S13, S21 to S23, S31 to S33 and S41 to S43 as shown in FIG. 13 according to the PLL gain coefficient GS. This enables adjustment of the open loop gain of the PLL circuit 3 to more details than that in the embodiment described above.

The phase detector 301 may adopt another phase comparison method capable of determining the phase difference between the disc playback signal and the extraction clock from the width of an activated UP or DOWN signal.

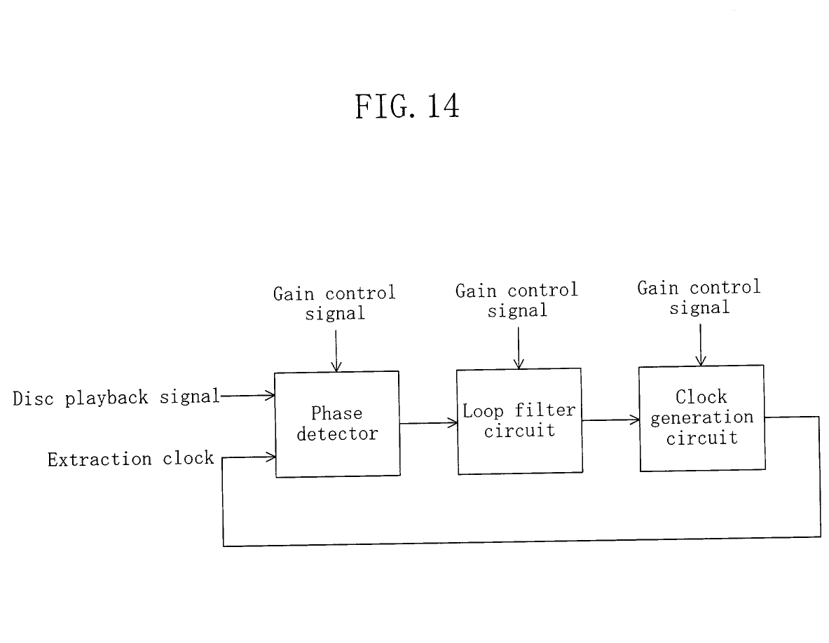

In the above embodiment, the constant current circuit 302, the filter circuit 303 and the voltage-controlled oscillator 304 of the PLL circuit 3 were implemented by analog circuits, to realize the phase control with analog amounts. Alternatively, as shown in FIG. 14, a digital PLL circuit configuration may be adopted, in which the phase difference between the disc playback signal and the extraction clock is digitally detected and digital operation is performed for the subsequent processing until the generation of the extraction clock. In this case, the same effect as that obtained in the above embodiment can be obtained by adjusting a coefficient and the like used in the digital arithmetic according to the gain control signals.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. An optical disc playback apparatus comprising:
a PLL circuit for generating an extraction clock synchronized with a disc playback signal;
a tracking error detection circuit for detecting a tracking error amount at a disc playback position; and
a gain control circuit for generating a control signal corresponding to the tracking error amount detected by the tracking error detection circuit,
wherein the PLL circuit generates the extraction clock with a loop gain corresponding to the control signal from the gain control circuit.

2. The apparatus of claim 1, wherein the PLL circuit comprises:
a phase detector for comparing the phase of the disc playback signal with the phase of the extraction clock and outputting a signal corresponding to the resultant phase difference;
a constant current circuit for outputting a current corresponding to the signal from the phase detector;
a filter circuit for converting the current output from the constant current circuit to a voltage and outputting the voltage; and
a voltage-controlled oscillator for generating a clock having a frequency corresponding to the level of the voltage output from the filter circuit.

3. The apparatus of claim 2, wherein the constant current circuit outputs a current of an amount corresponding to the control signal from the gain control circuit.

4. The apparatus of claim 2, wherein the filter circuit includes a resistance and a capacitor connected between an output node of the constant current circuit and a node for receiving a predetermined fixed voltage, and
the resistance value of the resistance is varied with the control signal from the gain control circuit.

5. The apparatus of claim 2, wherein the PLL circuit further comprises a frequency divider for dividing the frequency of the clock from the voltage-controlled oscillator and outputting the result as the extraction clock, and
the frequency divider divides the frequency of the clock from the voltage-controlled oscillator by a divisor corresponding to the control signal from the gain control circuit.

6. The apparatus of claim 2, wherein the phase detector compares the phase of the disc playback signal with the phase of the extraction clock at a frequency corresponding to the control signal from the gain control circuit.

7. The apparatus of claim 1, further comprising a dropout detection circuit for detecting a dropout of the disc playback signal,
wherein the gain control circuit outputs a holding signal when a dropout of the disc playback signal is detected by the dropout detection circuit, and
the PLL circuit holds the frequency of the extraction clock in response to the holding signal from the gain control circuit.

8. The apparatus of claim 1, wherein the gain control circuit normalizes the tracking error amount detected by the tracking error detection circuit so that the maximum of the tracking error amount is a predetermined value, and generates the control signal based on the normalized tracking error amount.

9. The apparatus of claim 1, wherein the gain control circuit accumulates the tracking error amount detected by the tracking error detection circuit for a predetermined period, and generates the control signal based on the accumulated tracking error amount.

10. The apparatus of claim 1, wherein the gain control circuit generates the control signal in different ways of correspondence with the tracking error amount detected by the tracking error detection circuit between during increase of the tracking error amount and during decrease of the tracking error amount.

11. The apparatus of claim 1, wherein the PLL circuit comprises:
a phase detector for detecting the phase difference between the disc playback signal and the extraction clock as a digital value;
an arithmetic circuit for performing predetermined arithmetic for the phase difference detected by the phase detector; and
a clock generation circuit for generating a clock having a frequency corresponding to the arithmetic result from the arithmetic circuit,
wherein the arithmetic circuit performs the predetermined arithmetic using an arithmetic coefficient corresponding to the control signal from the gain control circuit.

12. An optical disc playback apparatus comprising:
a PLL circuit for generating an extraction clock synchronized with a disc playback signal;
a focusing error detection circuit for detecting a focusing error amount at a disc playback position; and
a gain control circuit for generating a control signal corresponding to the focusing error amount detected by the focusing error detection circuit,
wherein the PLL circuit generates the extraction clock with a loop gain corresponding to the control signal from the gain control circuit.

13. The apparatus of claim 12, wherein the PLL circuit comprises:
a phase detector for comparing the phase of the disc playback signal with the phase of the extraction clock and outputting a signal corresponding to the resultant phase difference;
a constant current circuit for outputting a current corresponding to the signal from the phase detector;
a filter circuit for converting the current output from the constant current circuit to a voltage and outputting the voltage; and
a voltage-controlled oscillator for generating a clock having a frequency corresponding to the level of the voltage output from the filter circuit.

14. The apparatus of claim 13, wherein the constant current circuit outputs a current of an amount corresponding to the control signal from the gain control circuit.

15. The apparatus of claim 13, wherein the filter circuit includes a resistance and a capacitor connected between an output node of the constant current circuit and a node for receiving a predetermined fixed voltage, and
the resistance value of the resistance is varied with the control signal from the gain control circuit.

16. The apparatus of claim 13, wherein the PLL circuit further comprises a frequency divider for dividing the clock from the voltage-controlled oscillator and outputting the result as the extraction clock, and
the frequency divider divides the clock from the voltage-controlled oscillator by a divisor corresponding to the control signal from the gain control circuit.

17. The apparatus of claim 13, wherein the phase detector compares the phase of the disc playback signal with the phase of the extraction clock at a frequency corresponding to the control signal from the gain control circuit.

18. The apparatus of claim 12, wherein the gain control circuit outputs a holding signal when the focusing error amount detected by the focusing error detection circuit exceeds a predetermined value, and
the PLL circuit holds the frequency of the extraction clock in response to the holding signal from the gain control circuit.

19. The apparatus of claim 12, further comprising a dropout detection circuit for detecting a dropout of the disc playback signal,
wherein the gain control circuit outputs a holding signal when a dropout of the disc playback signal is detected by the dropout detection circuit, and
the PLL circuit holds the frequency of the extraction clock in response to the holding signal from the gain control circuit.

20. The apparatus of claim 12, wherein the gain control circuit normalizes the focusing error amount detected by the focusing error detection circuit so that the maximum of the focusing error amount is a predetermined value, and generates the control signal based on the normalized focusing error amount.

21. The apparatus of claim 12, wherein the gain control circuit accumulates the focusing error amount detected by the focusing error detection circuit for a predetermined period, and generates the control signal based on the accumulated focusing error amount.

22. The apparatus of claim 12, wherein the gain control circuit generates the control signal in different ways of correspondence with the focusing error amount detected by the focusing error detection circuit between during increase of the focusing error amount and during decrease of the focusing error amount.

23. The apparatus of claim 12, wherein the PLL circuit comprises:
a phase detector for detecting the phase difference between the disc playback signal and the extraction clock as a digital value;
an arithmetic circuit for performing predetermined arithmetic for the phase difference detected by the phase detector; and
a clock generation circuit for generating a clock of a frequency corresponding to the arithmetic result from the arithmetic circuit,
wherein the arithmetic circuit performs the predetermined arithmetic using an arithmetic coefficient corresponding to the control signal from the gain control circuit.

24. An optical disc playback apparatus comprising:
a PLL circuit for generating an extraction clock synchronized with a disc playback signal;
a tracking error detection circuit for detecting a tracking error amount at a disc playback position;
a focusing error detection circuit for detecting a focusing error amount at the disc playback position; and
a gain control circuit for generating a control signal corresponding to the tracking error amount detected by the tracking error detection circuit and the focusing error amount detected by the focusing error detection circuit,
wherein the PLL circuit generates the extraction clock with a loop gain corresponding to the control signal from the gain control circuit.

25. The apparatus of claim 24, wherein the PLL circuit comprises:
a phase detector for comparing the phase of the disc playback signal with the phase of the extraction clock and outputting a signal corresponding to the resultant phase difference;
a constant current circuit for outputting a current corresponding to the signal from the phase detector;
a filter circuit for converting the current output from the constant current circuit to a voltage and outputting the voltage; and
a voltage-controlled oscillator for generating a clock having a frequency corresponding to the level of the voltage output from the filter circuit.

26. The apparatus of claim 25, wherein the constant current circuit outputs a current of an amount corresponding to the control signal from the gain control circuit.

27. The apparatus of claim 25, wherein the filter circuit includes a resistance and a capacitor connected between an output node of the constant current circuit and a node for receiving a predetermined fixed voltage, and
the resistance value of the resistance is varied with the control signal from the gain control circuit.

28. The apparatus of claim 25, wherein the PLL circuit further comprises a frequency divider for dividing the clock from the voltage-controlled oscillator and outputting the result as the extraction clock,
wherein the frequency divider divides the clock from the voltage-controlled oscillator by a divisor corresponding to the control signal from the gain control circuit.

29. The apparatus of claim 25, wherein the phase detector compares the phase of the disc playback signal with the phase of the extraction clock at a frequency corresponding to the control signal from the gain control circuit.

30. The apparatus of claim 24, wherein the gain control circuit multiplies the tracking error amount detected by the tracking error detection circuit by a first coefficient, multiples the focusing error amount detected by the focusing error detection circuit by a second coefficient, and generates the control signal based on the first coefficient-multiplied tracking error amount and the second coefficient-multiplied focusing error amount.

31. The apparatus of claim 24, wherein the gain control circuit outputs a holding signal when the focusing error amount detected by the focusing error detection circuit exceeds a predetermined value, and
the PLL circuit holds the frequency of the extraction clock in response to the holding signal from the gain control circuit.

32. The apparatus of claim 24, further comprising a dropout detection circuit for detecting a dropout of the disc playback signal,
wherein the gain control circuit outputs a holding signal when a dropout of the disc playback signal is detected by the dropout detection circuit, and
the PLL circuit holds the frequency of the extraction clock in response to the holding signal from the gain control circuit.

33. The apparatus of claim 24, wherein the gain control circuit normalizes the tracking error amount detected by the tracking error detection circuit so that the maximum of the tracking error amount is a predetermined value, and generates the control signal based on the normalized tracking error amount.

34. The apparatus of claim 24, wherein the gain control circuit normalizes the focusing error amount detected by the focusing error detection circuit so that the maximum of the focusing error amount is a predetermined value, and generates the control signal based on the normalized focusing error amount.

35. The apparatus of claim 24, wherein the gain control circuit accumulates the tracking error amount detected by the tracking error detection circuit for a predetermined period, and generates the control signal based on the accumulated tracking error amount.

36. The apparatus of claim 24, wherein the gain control circuit accumulates the focusing error amount detected by the focusing error detection circuit for a predetermined period, and generates the control signal based on the accumulated focusing error amount.

37. The apparatus of claim 24, wherein the gain control circuit generates the control signal in different ways of correspondence with the tracking error amount detected by the tracking error detection circuit between during increase of the tracking error amount and during decrease of the tracking error amount.

38. The apparatus of claim 24, wherein the gain control circuit generates the control signal in different ways of correspondence with the focusing error amount detected by the focusing error detection circuit between during increase of the focusing error amount and during decrease of the focusing error amount.

39. The apparatus of claim 24, wherein the PLL circuit comprises:
a phase detector for detecting the phase difference between the disc playback signal and the extraction clock as a digital value;
an arithmetic circuit for performing predetermined arithmetic for the phase difference detected by the phase detector; and
a clock generation circuit for generating a clock of a frequency corresponding to the arithmetic result from the arithmetic circuit,
wherein the arithmetic circuit performs the predetermined arithmetic using an arithmetic coefficient corresponding to the control signal from the gain control circuit.
